(19) United States
(12) Patent Application Publication
(10) Pub. No.: US 2015/0052306 A1
(43) Pub. Date: Feb. 19, 2015

(54) PROCESSOR AND CONTROL METHOD OF PROCESSOR

(71) Applicant: FUJITSU LIMITED, Kawasaki-shi (JP)

(72) Inventor: Yuji Shirahige, Kawasaski (JP)

(21) Appl. No.: 14/334,092

(22) Filed: Jul. 17, 2014

(30) Foreign Application Priority Data
Aug. 19, 2013 (JP) 2013-169492

(51) Int. Cl. G06F 12/08; G06F 9/30; G06F 12/14

(52) U.S. Cl. CPC G06F 12/0875; G06F 12/1466; G06F 9/3009
USPC 711/125

(57) ABSTRACT

Lock information indicating that an address is locked and a lock address are held for each thread, and in a case where the execution of a CAS instruction is requested, a primary cache controller which receives a request from an instruction controlling unit which requests processing according to an instruction in each thread executes a plurality of pieces of processing included in the CAS instruction when an access target address of the CAS instruction is different from the lock address of a thread whose lock information is held, and prohibits the execution of store processing of a thread whose lock information is not held, to a cache memory when the lock information of any thread out of the plural threads is held.

### CROSS-REFERENCE TO RELATED APPLICATION

This application is based upon and claims the benefit of priority of the prior Japanese Patent Application No. 2013-169492, filed on Aug. 19, 2013, the entire contents of which are incorporated herein by reference.

### FIELD

The embodiment discussed herein is directed to a processor and a control method of a processor.

### BACKGROUND

Some processor is capable of performing a memory access by an atomic instruction whose plurality of pieces of processing are indivisibly executed, such as a CAS (Compare And Swap) instruction. Here, the atomic instruction means an instruction that guarantees that the same result is obtained as when the plural pieces of processing are executed in a specific order. Fetch processing, comparison processing, and store processing of data relating to the CAS instruction are executed with a single instruction. During a period from the fetching to the storing relating to the CAS instruction, referring to and updating of the target data by other instructions are prohibited.

Therefore, there is a rule that the CAS instruction do not go ahead of instructions preceding the CAS instruction, and instructions succeeding the CAS instruction do not go ahead of the CAS instruction. Before the execution of the CAS instruction, the completion of a preceding request is waited for and during the execution of the CAS instruction, a succeeding request is not processed. Further, in order to keep atomicity, data is generally protected by locking during the execution of the CAS instruction.

The operation by the CAS instruction in a conventional processor will be described with reference to FIG. 11, FIG. 12, and FIG. 13. Note that it is assumed in the description below that the processor is a multi-threaded processor capable of executing a plurality of threads concurrently. The CAS instruction is executed by three operation flows, a first operation flow, a second operation flow, and a third operation flow, according to the flowcharts illustrated in FIG. 11, FIG. 12, and FIG. 13.

FIG. 11 is a flowchart illustrating the first operation flow relating to the execution of the CAS instruction. A primary cache controller that a core of the processor has registers the CAS instruction received from an instruction controlling unit that the core has, in a fetch port and a store port (S401). Then, the primary cache controller supplies a first request relating to the CAS instruction to a pipeline from the fetch port (S402).

Here, sequence control is performed at the fetch port, so that it can be determined whether or not the request is the oldest request in the fetch port. The CAS instruction is executed after it becomes the oldest request in the fetch port, that is, after all the preceding requests are processed. The pipeline of the primary cache controller determines whether or not the supplied first request is the oldest request in the fetch port (S403).

When, as a result of the determination at step S403, the supplied first request is not the oldest request in the fetch port, the first request is aborted, and the flow returns to step S402. On the other hand, when the supplied first request is the oldest request in the fetch port, the pipeline of the primary cache controller confirms whether or not another thread sets a lock flag in a lock register (S404). The lock flag is set (for example, its value is set to “1”) during the execution of the CAS instruction and is cleared (for example, its value is set to “0”) when the CAS instruction is completed.

When, as a result of the confirmation at step S404, another thread sets the lock flag, the supplied first request is aborted and the flow returns to step S402. On the other hand, when any other thread does not set the lock flag, the pipeline of the primary cache controller sets the lock flag in the lock register (S405) to finish the first operation flow.

FIG. 12 is a flowchart illustrating the second operation flow relating to the execution of the CAS instruction, which is executed subsequently to the first operation flow illustrated in FIG. 11. The primary cache controller supplies a second request relating to the CAS instruction from the fetch port to the pipeline (S501). The pipeline of the primary cache controller obtains data from an address designated by the supplied second request to send the data to an arithmetic unit that the core has (S502), and finishes the second operation flow.

FIG. 13 is a flowchart illustrating the third operation flow relating to the execution of the CAS instruction, which is executed subsequently to the second operation flow illustrated in FIG. 12 according to the comparison result in the arithmetic unit. The primary cache controller supplies a third request (store request) relating to the CAS instruction from the store port to the pipeline (S601). The pipeline of the primary cache controller writes the data to an address designated by the supplied third request (S602). Then, the pipeline of the primary cache controller clears the lock flag (S603) and finishes the third operation flow, thereby completing the CAS instruction.

In a conventional single-threaded processor, the number of CAS instructions executed concurrently is one. But in a multi-threaded processor, the number of CAS instructions that can be executed concurrently is one for each thread in principle, that is, the same number of CAS instructions as the number of the threads can be executed concurrently. However, while a lock flag is set in a lock register, pieces of pipeline processing by other threads are all aborted. Therefore, when the execution of CAS instructions is requested in a plurality of threads, these CAS instructions are processed one by one as illustrated in FIG. 14.

FIG. 14 is a timing chart illustrating an operation example in a conventional processor. In the example illustrated in FIG. 14, a pipeline of a primary cache controller has five stages, a priority stage (P), a TAG/TLB access stage (T), a match stage (M), a buffer access stage (B), and a result stage (R).

At the priority stage, a request to be supplied to pipeline processing is selected and supplied according to a priority sequence. At the TAG/TLB access stage, a TAG memory holding tag data and so on relating to data is accessed, and a virtual address is converted to a physical address in TLB (Translation Lookaside Buffer), and a data cache memory is accessed.

At the match stage, an output from the TAG memory and the physical address converted in the TLB are compared, and a read way (WAY) of the cache memory is decided. At the buffer access stage, a way is selected by using the result at the match stage, and the data is given to an arithmetic unit. At the result stage, a check result on correctness of the data at the buffer access stage is reported.

In FIG. 14, the pipeline of the primary cache controller sets a lock flag (th0-CAS-LOCk) relating to a CAS instruction (th0-CAS) of a thread 0 at the fifth cycle. The pipeline of the primary cache controller aborts a succeeding CAS instruction (th1-CAS) of a thread 1 since the lock flag (th0-CAS-LOCK) is set. Further, it similarly aborts the CAS instruction (th1-CAS) of the thread 1 starting from the tenth cycle. Incidentally, the confirmation of the lock flag is performed at the buffer access stage.

The pipeline of the primary cache controller executes a second operation flow relating to the CAS instruction (th0-CAS) of the thread 0 from the eighth cycle and sends fetched data to the arithmetic unit at the eleventh cycle. The pipeline of the primary cache controller executes a third operation flow relating to the CAS instruction (th0-CAS) of the thread 0 from the fifteenth cycle to write the data to a cache memory and clears the lock flag (th0-CAS-LOCK) at the eighteenth cycle.

Since the lock flag (th0-CAS-LOCK) is cleared at the eighteenth cycle, the pipeline of the primary cache controller sets, at the twenty-first cycle, a lock flag (th1-CAS-LOCK) relating to the CAS instruction (th1-CAS) of the thread 1 starting from the seventeenth cycle. Thereafter, the pipeline of the primary cache controller executes a second operation flow relating to the CAS instruction (th1-CAS) of the thread 1 from the twenty-fourth cycle, executes a third operation flow from the thirty-first cycle, and clears the lock flag (th1-CAS-LOCK) at the thirty-fourth cycle.

Pieces of pipeline processing by other threads are all aborted while the lock flag is set, and therefore, when the execution of CAS instructions is requested in a plurality of threads in the multi-threaded processor, these CAS instructions are processed one by one. Thus executing only one CAS instruction at a time lowers processing performance when the CAS instruction frequently occurs in a multi-threaded environment.

In the multi-threaded processor, there has been proposed an art in which a flag indicating whether or not an atomic instruction is being executed and an address of an access destination of the atomic instruction are stored for each thread, and when an access request is issued from some thread, the stored flag and address are referred to, and when it is determined that another thread is executing an atomic instruction and access destinations of this atomic instruction and the access request are the same, the processor keeps the access request on standby (for example, refer to Patent Document 1). Further, there has been proposed an art in which a memory address and a lock bit indicating that this memory address is locked are stored in a register for each stream being executed for processing a thread, and when the lock bit is set, processing having atomicity to the same memory position is made to stall until the lock bit is cleared (for example, refer to Patent Document 2).
[Patent Document 1] International Publication Pamphlet No. WO 2008/155827
[Patent Document 2] Japanese National Publication of International Patent Application No. 2004-503864
[Patent Document 3] Japanese Laid-open Patent Publication No. 54-159841
[Patent Document 4] Japanese Laid-open Patent Publication No. 2003-30166

In a multi-threaded processor capable of executing a plurality of threads concurrently, if CAS instructions of different threads are simply made executable, there may occur a deadlock as described below. For example, as illustrated in FIG. 15, it is assumed that a CAS instruction (th0-CAS) of a thread 0 starts from the first cycle and a CAS instruction (th1-CAS) of a thread 1 starts from the fourth cycle.

At this time, a pipeline of a primary cache controller sets a lock flag (th0-CAS-LOCK) relating to the CAS instruction (th0-CAS) of the thread 0 at the fifth cycle. Further, the pipeline of the primary cache controller sets a lock flag (th1-CAS-LOCK) relating to the CAS instruction (th1-CAS) of the thread 1 at the eighth cycle. Here, in order to keep atomicity of the CAS instruction, the execution of store processing in the own thread is prohibited when the other thread sets the locking (the lock flag is set).

In FIG. 15, from the eighth cycle on, since the lock flag (th0-CAS-LOCK) of the thread 0 and the lock flag (th1-CAS-LOCK) of the thread 1 are set concurrently, the execution of the store processing of the thread 0 and that of the thread 1 are prohibited by each other. That is, the primary cache controller can supply the pipeline with neither a third request (store request) relating to the CAS instruction (th0-CAS) of the thread 0 nor a third request (store request) relating to the CAS instruction (th1-CAS) of the thread 1. As a result, the pipeline of the primary cache controller can execute neither the store processing in the thread 0 nor that in the thread 1, so that the lock flags (th0-CAS-LOCK, th1-CAS-LOCK) are not cleared. That is, it gets into a deadlock.

### SUMMARY

According to an aspect of the embodiment, a processor includes: a cache memory which holds data; an instruction controlling unit which requests processing according to an instruction in each of a plurality of threads; an address holding unit which holds, for each of the threads, lock information indicating that an address is locked and a lock target address in correspondence to each of the threads; and a cache controlling unit which, in a case where execution of an atomic instruction whose plurality of pieces of processing including an access to the cache memory are indivisibly executed is requested from the instruction controlling unit, executes the plural pieces of processing included in the atomic instruction when an access target address of the atomic instruction whose execution is requested is different from the lock target address of a thread whose lock information is held in the address holding unit, and prohibits execution of store processing of a thread whose lock information is not held in the address holding unit, to the cache memory when the lock information of any thread out of the plural threads is held in the address holding unit.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration example of a processor in an embodiment;

FIG. 2 is a diagram illustrating a configuration example of a primary cache controller in this embodiment;

FIG. 3, FIG. 4 and FIG. 5 are flowcharts illustrating operation examples of the processor in this embodiment;

FIG. 6 is a chart illustrating supply control of store requests in this embodiment;

FIG. 7 is a diagram illustrating a configuration example of the primary cache controller relating to the operation illustrated in FIG. 3;

FIG. 8 is a diagram illustrating a configuration example of the primary cache controller relating to the operation in FIG. 5;

FIG. 9 and FIG. 10 are timing charts illustrating operation examples of the processor in this embodiment;

FIG. 11, FIG. 12 and FIG. 13 are flowcharts illustrating conventional processing operations relating to the execution of a CAS instruction;

FIG. 14 is a timing chart illustrating a conventional operation example relating to the execution of CAS instructions; and

FIG. 15 is an explanatory chart of a problem when CAS instructions of different threads are made executable concurrently.

### DESCRIPTION OF EMBODIMENTS

Hereinafter, an embodiment will be described with reference to the drawings.

In an embodiment described below, an address in a locked state is held in a lock register, and when an access target address of a CAS instruction is different from the lock target address held in the lock register of another thread, this CAS instruction is made executable, thereby enabling the concurrent execution of the CAS instructions. Further, by providing a supply condition of a third request (store request) relating to the CAS instruction, the occurrence of a deadlock is avoided.

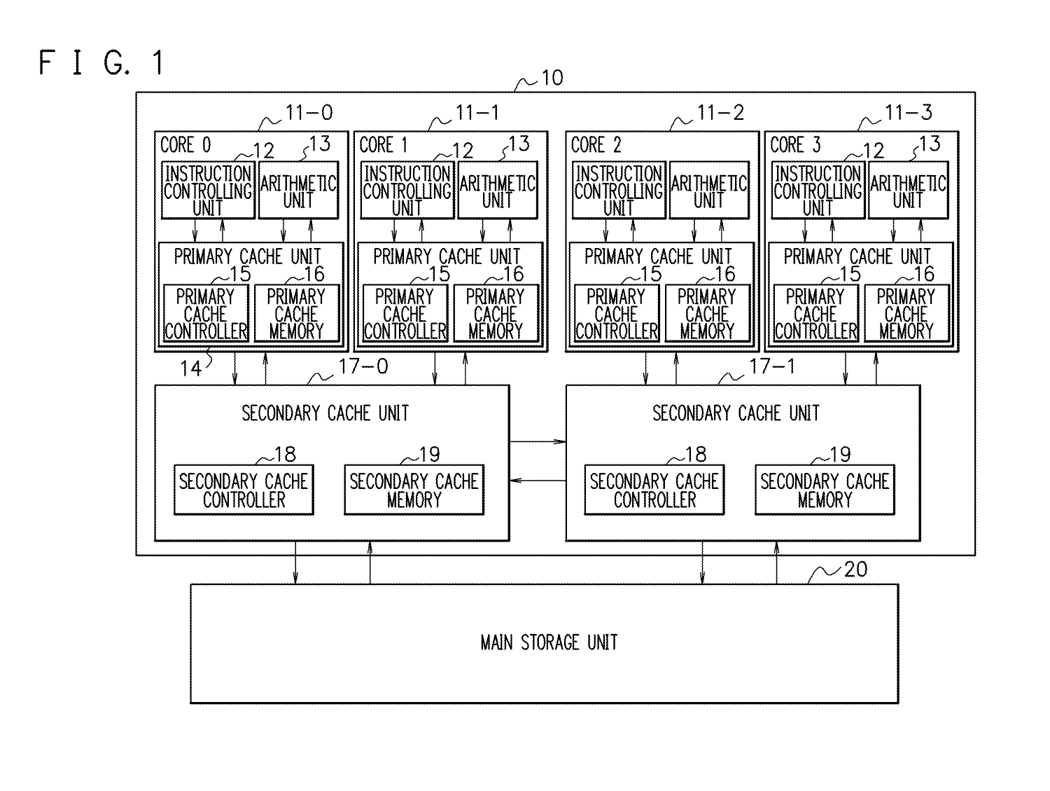

FIG. 1 is a diagram illustrating a configuration example of a processor 10 in this embodiment. The processor 10 has a plurality of cores 11 and a plurality of secondary cache units 17. The cores 11 operate with multi-threads (a plurality of threads), and two threads, for example, a thread 0 and a thread 1, are executable.

Note that the numbers of the cores 11 and the secondary cache units 17 that the processor 10 has may be any, though an example where four cores 11-0 to 11-3 and two secondary cache units 17-0, 17-1 are provided is illustrated in FIG. 1. Further, though FIG. 1 illustrates an example where the two cores 11 share the single secondary cache unit 17, the number of the cores 11 sharing the single secondary cache unit 17 may be also any. For example, the processor 10 may have the single secondary cache unit 17 and it may be shared by all the cores that the processor 10 has.

The cores 11 each have an instruction controlling unit 12, an arithmetic unit 13, and a primary cache unit 14. The instruction controlling unit 12 controls the execution of an instruction and requests processing corresponding to the instruction in each of a plurality of threads. The arithmetic unit 13 performs an arithmetic operation according to the control by the instruction controlling unit 12. For example, the arithmetic unit 13 performs comparison processing of data relating to the CAS instruction. The primary cache unit 14 has a primary cache controller 15 as a cache controlling unit which receives the request from the instruction controlling unit 12 and a primary cache memory 16 which holds data. The primary cache unit 14 performs the processing requested from the instruction controlling unit 12. For example, upon receiving a data transfer request from the instruction controlling unit 12, the primary cache controller 15 returns requested data when the data is in the primary cache memory 16, and otherwise, issues a data transfer request to the secondary cache unit 17.

The secondary cache units 17 each have a secondary cache controller 18 which receives the request from the primary cache controller 15 of the core 11 and a secondary cache memory 19 which holds data. For example, upon receiving the data transfer request from the primary cache controller 15, the secondary cache controller 18 returns requested data when the data is in the secondary cache memory 19, and otherwise, issues a data transfer request to an external main storage unit 20.

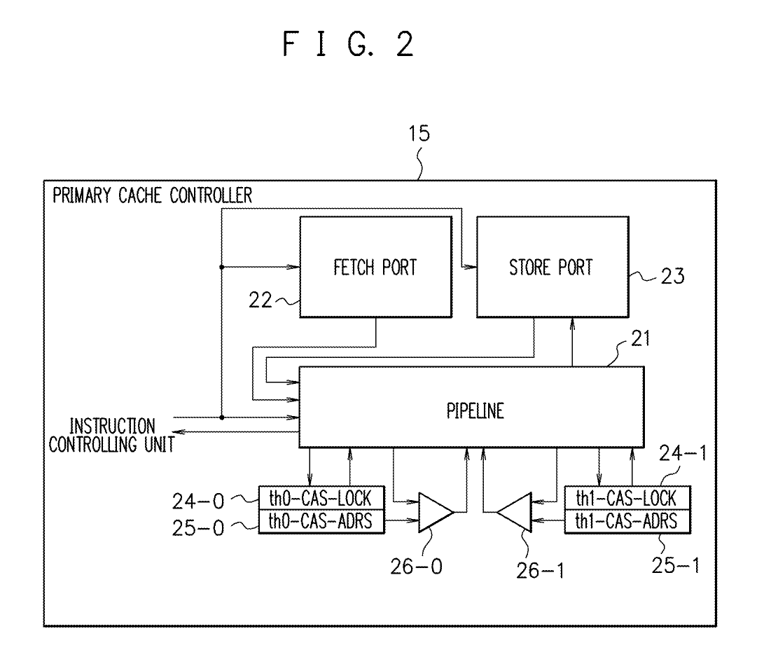

FIG. 2 is a diagram illustrating a configuration example of the primary cache controller 15 in this embodiment. The primary cache controller 15 has a pipeline 21, a fetch port 22, a store port 23, lock registers 24 (24-0, 24-1), 25 (25-0, 25-1) as address holding units, and address comparators 26 (26-0, 26-1).

The pipeline 21 receives requests from the fetch port 22 and the store port 23 to execute processing according to the requests. The pipeline 21 has five stages, a priority stage (P), a TAG/TLB access stage (T), a match stage (M), a buffer access stage (B), and a result stage (R). Incidentally, in this embodiment, the pipeline 21 has the five stages, but this is not restrictive, and the pipeline 21 may be a pipeline having a different number of stages, for example, having four stages.

At the priority stage, a request to be supplied to pipeline processing is selected and supplied according to a priority sequence. At the TAG/TLB access stage, a TAG memory which holds tag data and the like relating to data is accessed and a virtual address is converted to a physical address in TLB, and a data cache memory is accessed. At the match stage, an output from the TAG memory and the physical address converted in the TLB are compared, and a read way (WAY) of the cache memory is decided. At the buffer access stage, a way is selected by using the result at the match stage and the data is given to the arithmetic unit. At the result stage, the check result on correctness of the data at the buffer access stage is reported.

The fetch port 22 has a plurality of entries which hold requests received from the instruction controlling unit 12. The requests from the instruction controlling unit 12 are cyclically allocated to and held in the entries of the fetch port 22 in order of issuance, and the requests held in the fetch port 22 are read and supplied to the pipeline 21 out of order.

The store port 23 has a plurality of entries which hold store requests received from the instruction controlling unit 12. The store requests from the instruction controlling unit 12 are cyclically allocated to and held in the entries of the store port 23 in order of issuance, and the store requests held in the store port 23 are read to be supplied to the pipeline 21 out of order.

The lock register (24-0, 25-0) of the thread 0 holds a lock flag (th0-CAS-LOCK) of the thread 0 in a field 24-0 and holds a locked address (lock address) (th0-CAS-ADRS) of the thread 0 in a field 25-0. The lock register (24-1, 25-1) of the thread 1 holds a lock flag (th1-CAS-LOCK) of the thread 1 in a field 24-1 and holds a locked address (lock address) (th1-CAS-ADRS) of the thread 1 in a field 25-1.

The address comparator 26-0 compares an access address of a request being executed in the pipeline 21 and the lock address (th0-CAS-ADRS) of the thread 0 held in the lock register 25-0 to output the comparison result. The address comparator 26-1 compares the access address of the request being executed in the pipeline 21 and the lock address (th1-CAS-ADRS) of the thread 1 held in the lock register 25-1 to output the comparison result.

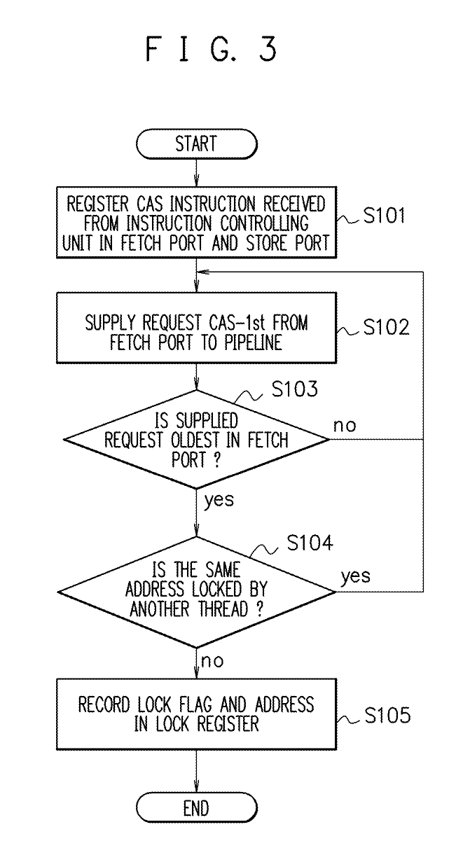

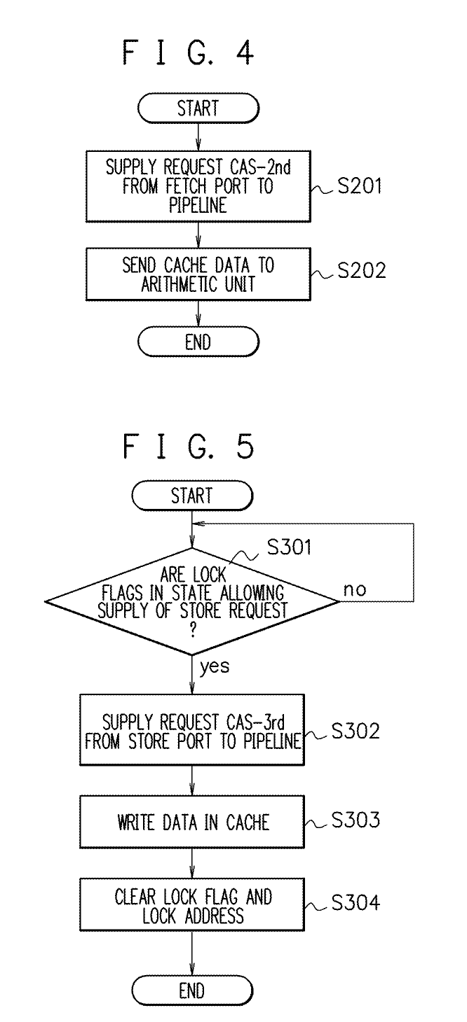

Next, the operation of the processor 10 in this embodiment will be described. Hereinafter, the operation relating to a CAS instruction which is one of atomic instructions whose plurality of pieces of processing are indivisibly executed will be described with reference to FIG. 3, FIG. 4 and FIG. 5. The CAS instruction is executed by three operation flows, a first operation flow, a second operation flow, and a third operation flow, according to the flowcharts illustrated in FIG. 3, FIG. 4, and FIG. 5.

FIG. 3 is a flowchart illustrating the first operation flow relating to the execution of the CAS instruction in the processor 10 in this embodiment. The primary cache controller 15 that the primary cache unit 14 of the core 11 has registers the CAS instruction received from the instruction controlling unit 12 in the fetch port 22 and the store port 23 (S101). Then, the primary cache controller 15 supplies a first request relating to the CAS instruction from the fetch port 22 to the pipeline 21 (S102).

Next, the pipeline 21 of the primary cache controller 15 determines whether or not the supplied first request is the oldest request in the fetch port 22 (S103). When, as a result of the determination, the supplied first request is not the oldest request in the fetch port 22, the first request is aborted and the flow returns to step S102.

When, as a result of the determination at step S103, the supplied first request is the oldest request in the fetch port 22, the pipeline 21 of the primary cache controller 15 confirms whether or not the same address is locked by another thread (S104). That is, the pipeline 21 determines whether or not an access address of the supplied CAS instruction agrees with the lock address held in the lock register in which the lock flag is set, based on the comparison result output from the address comparator 26.

When, as a result of the confirmation at step S104, the same address is locked by another thread, the supplied first request is aborted and the flow returns to step S102. On the other hand, when the same address is not locked by any other thread, the pipeline 21 of the primary cache controller 15 sets the lock flag and records the lock address in the lock register (24, 25) of the corresponding thread (S105), to end the first operation flow.

In the exclusive control only by the lock flag, the CAS instruction is executed after the completion of a CAS instruction of another thread even if addresses are different. On the other hand, in this embodiment, the exclusive control is performed by using the lock flag and the lock address, and therefore even if a CAS instruction of some thread is being executed, it is possible to execute a CAS instruction of another thread to a different address, which enables the concurrent execution of the CAS instructions.

FIG. 4 is a flowchart illustrating the second operation flow relating to the execution of the CAS instruction in the processor 10 in this embodiment, which is executed subsequently to the first operation flow illustrated in FIG. 3. The primary cache controller 15 supplies a second request relating to the CAS instruction from the fetch port 22 to the pipeline 21 (S201). The pipeline 21 of the primary cache controller 15 obtains data from an address designated by the supplied second request to send the obtained data to the arithmetic unit 13 (S202), and finishes the second operation flow.

FIG. 5 is a flowchart illustrating the third operation flow relating to the execution of the CAS instruction in the processor 10 in this embodiment, which is executed subsequently to the second operation flow illustrated in FIG. 4 according to the comparison result in the arithmetic unit.

The pipeline 21 of the primary cache controller 15 determines whether or not a state of the lock flags held in the lock registers 24 is a state allowing the supply of a store request (S301). Incidentally, this determination processing uses the lock flags held in the lock register 24 and does not use the lock addresses held in the lock register 25.

When the lock flag of at least one thread is set, the pipeline 21 of the primary cache controller 15 determines that a store request of the thread whose lock flag is set can be supplied, while determining that the supply of a store request of a thread whose lock flag is cleared is not allowed. By thus prohibiting the execution of the store processing of the thread whose lock flag is cleared, atomicity is kept. When the lock flags of all the threads are cleared, the pipeline 21 of the primary cache controller 15 determines that the store requests of all the threads can be supplied.

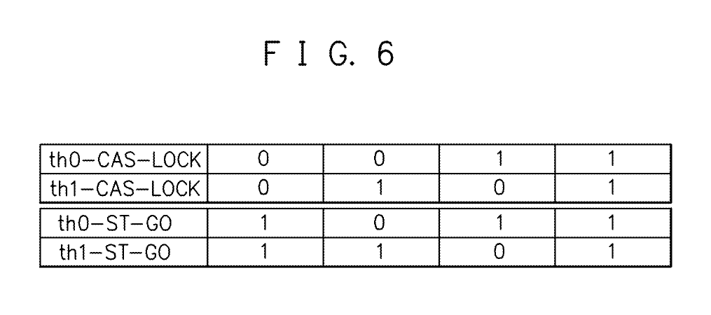

The pipeline 21 of the primary cache controller 15 determines whether or not the supply of the store request is allowed according to a truth table illustrated in FIG. 6, for instance. Specifically, when the lock flag (th0-CAS-LOCK) of the thread 0 and the lock flag (th1-CAS-LOCk) of the thread 1 are both cleared (their values are “0”), the pipeline 21 of the primary cache controller 15 determines that the supply of the store requests of both the threads 0, 1 is allowed. These store requests are not store requests relating to the CAS instructions but are other store requests.

When one of the lock flag (th0-CAS-LOCK) of the thread 0 and the lock flag (th1-CAS-LOCK) of the thread 1 is set (its value is “1”) and the lock flag of the other is cleared (its value is “0”), the pipeline 21 of the primary cache controller 15 determines that the supply of the store request of only the thread whose lock flag is set is allowed. The store request supplied in this state is a store request relating to the CAS instruction. By thus prohibiting the store processing of the thread whose lock flag is cleared, it is possible to keep atomicity.

When the lock flag (th0-CAS-LOCK) of the thread 0 and the lock flag (th1-CAS-LOCK) of the thread 1 are both set (their values are “1”), the pipeline 21 of the primary cache controller 15 determines that the supply of the store requests of both the threads 0, 1 is allowed. As previously described, the CAS instructions of the threads 0, 1 are executed concurrently only when the addresses of their access targets are different, and even if the store requests relating to the CAS instructions of both the threads 0, 1 are supplied, atomicity is guaranteed, and therefore, it is possible to supply the store requests and the occurrence of a deadlock can be avoided.

When, as a result of the determination at step S301, it is determined that the supply of the store request is allowed, the pipeline 21 of the primary cache controller 15 supplies a third request (store request) relating to the CAS instruction from the store port 22 to the pipeline 21 (S302). The pipeline 21 of the primary cache controller 15 writes data to an address designated by the supplied third request (S303). Then, the pipeline 21 of the primary cache controller 15 clears the lock flag and the lock address of the lock register (24, 25) of the corresponding thread (S304) to finish the third operation flow, thereby completing the CAS instruction.

As described above, in this embodiment, the condition for the supply of the store request is provided, and the supply of the store request is controlled according to the lock flag held in the lock register 24. Consequently, even when the CAS instructions are executed concurrently, it is possible to supply the store request while guaranteeing atomicity, and the deadlock does not occur.

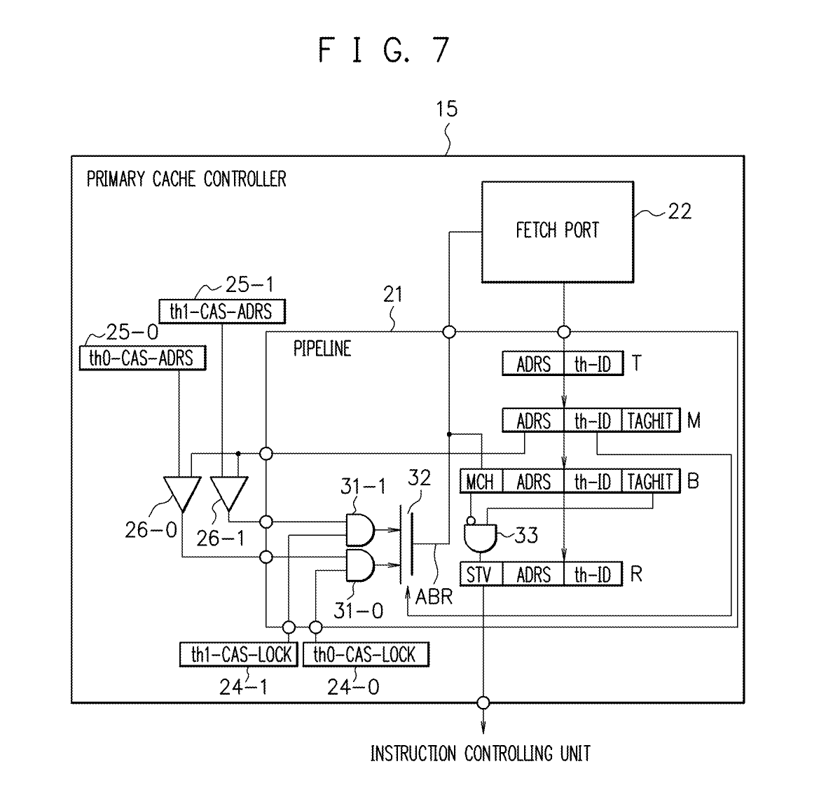

FIG. 7 is a diagram illustrating a configuration example of the pipeline relating to the first operation flow in this embodiment illustrated in FIG. 3. In FIG. 7, constituent elements having the same functions as those of the constituent elements illustrated in FIG. 2 are denoted by the same reference signs, and a redundant description thereof will be omitted.

The address comparator 26-0 compares an address (ADRS) at the match stage (M) of the request being executed in the pipeline 21 with the lock address (th0-CAS-ADRS) of the thread 0 held in the lock register 25-0. When the address (ADRS) at the match stage and the lock address (th0-CAS-ADRS) of the thread 0 agree with each other, the address comparator 26-0 outputs a value “1” (true) as the comparison result, and otherwise outputs a value “0” (false) as the comparison result.

The address comparator 26-1 compares the address (ADRS) at the match stage (M) of the request being executed in the pipeline 21 with the lock address (th1-CAS-ADRS) of the thread 1 held in the lock register 25-1. When the address (ADRS) at the match stage and the lock address (th1-CAS-ADRS) of the thread 1 agree with each other, the address comparator 26-1 outputs a value “1” (true) as the comparison result, and otherwise, outputs a value “0” (false) as the comparison result.

The pipeline 21 has, as output circuits, logical product operation (AND) circuits 31-0, 31-1 and a selector 32. The AND circuit 31-0 receives the output of the address comparator 26-0 and the lock flag (th0-CAS-LOCK) of the thread 0 held in the lock register 24-0 and outputs the arithmetic operation result of these. The AND circuit 31-1 receives the output of the address comparator 26-1 and the lock flag (th1-CAS-LOCK) of the thread 1 held in the lock register 24-1 and outputs the arithmetic operation result of these.

Specifically, when the lock flag (th0-CAS-LOCK) of the thread 0 is set and the address (ADRS) at the match stage and the lock address (th0-CAS-ADRS) of the thread 0 agree with each other, a value of the output of the AND circuit 31-0 becomes “1” (true), and otherwise, the value of the output of the AND circuit 31-0 becomes “0” (false). When the lock flag (th1-CAS-LOCK) of the thread 1 is set and the address (ADRS) at the match stage and the lock address (th1-CAS-ADRS) of the thread 1 agree with each other, a value of the output of the AND circuit 31-1 becomes “1” (true), and otherwise, the value of the output of the AND circuit 31-1 becomes “0” (false).

The selector 32 outputs, as a signal ABR, the output of the AND circuit 31-0 or the output of the AND circuit 31-1 according to thread information (th-ID) at the match stage (M) which information indicates a thread issuing the request being executed in the pipeline 21. That is, when the thread information (th-ID) indicates the thread 0, the selector 32 outputs, as the signal ABR, the output of the AND circuit 31-1 which is an output according to the lock flag (th1-CAS-LOCK) and the lock address (th1-CAS-ADRS) of the thread 1. When the thread information (th-ID) indicates the thread 1, the selector 32 outputs, as the signal ABR, the output of the AND circuit 31-0 which is an output according to the lock flag (th0-CAS-LOCK) and the lock address (th0-CAS-ADR) of the thread 0.

Therefore, in a case where the request of the thread 0 is being executed in the pipeline 21, when the lock flag (th1-CAS-LOCK) of the thread 1 is set and the address (ADRS) at the match stage and the lock address (th1-CAS-ADRS) of the thread 1 agree with each other, a value of the signal ABR becomes “1” indicating ABORT. Further, in a case where the request of the thread 1 is being executed in the pipeline 21, when the lock flag (th0-CAS-LOCK) of the thread 0 is set and the address (ADRS) at the match stage and the lock address (th0-CAS-ADRS) of the thread 0 agree with each other, the value of the signal ABR becomes “1” indicating ABORT.

The signal ABR is notified to the fetch port 22 and registered in a pipeline register as MATCH (MCH). An AND circuit 33 of the pipeline 21 performs a logical product operation of the inverted MATCH (MCH) and the tag hit (TAGHIT) at the buffer access stage (B) of the request being executed, and the arithmetic operation result is set as a signal STV. Here, the signal STV is a signal notifying to the instruction controlling unit 12 that data at the buffer access stage is valid. Therefore, when the signal ABR has the value “1” indicating ABORT, the signal STV becomes off (value “0”) at the buffer access stage (B) of the request being executed.

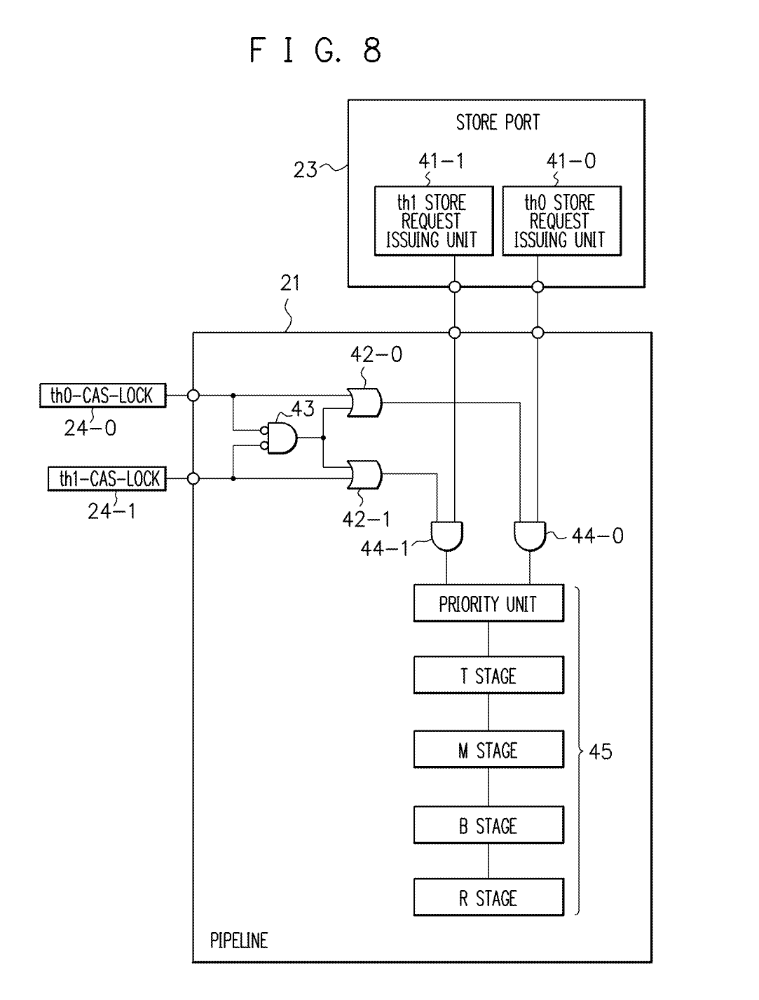

FIG. 8 is a diagram illustrating a configuration example of the pipeline relating to the third operation flow in this embodiment illustrated in FIG. 5. In FIG. 8, constituent elements having the same functions as those of the constituent elements illustrated in FIG. 2 are denoted by the same reference signs and a redundant description thereof will be omitted. The pipeline 21 has logical sum operation (OR) circuits 42-0, 42-1 and an AND circuit 43 as determining circuits, and AND circuits 44-0, 44-1 as prohibiting circuits.

The OR circuit 42-0 receives the lock flag (th0-CAS-LOCK) of the thread 0 held in the lock register 24-0 and an output of the AND circuit 43 and outputs the arithmetic operation result of these. The OR circuit 42-1 receives the lock flag (th1-CAS-LOCK) of the thread 1 held in the lock register 24-1 and the output of the AND circuit 43 and outputs the arithmetic operation result of these. The AND circuit 43 receives the lock flag (th0-CAS-LOCK) of the thread 0 and the lock flag (th1-CAS-LOCk) of the thread 1 which are both inverted, and outputs the arithmetic operation result of these.

The AND circuit 44-0 receives a store request issued by a store request issuing unit 41-0 for the thread 0 that the store port 23 has and an output of the OR circuit 42-0. The AND circuit 44-1 receives a store request issued by a store request issuing unit 41-1 for the thread 1 that the store port 23 has and an output of the OR circuit 42-1.

According to the configuration illustrated in FIG. 8, when the lock flag (th0-CAS-LOCK) of the thread 0 and the lock flag (th1-CAS-LOCK) of the thread 1 are both cleared (their values are “0”), values of the outputs of the OR circuits 42-0, 42-1 both become “1”. Therefore, the store request issued by the store request issuing unit 41-0 for the thread 0 is supplied to a processing unit 45 of the pipeline via the AND circuit 44-0, and the store request issued by the store request issuing unit 41-1 for the thread 1 is supplied to the processing unit 45 of the pipeline via the AND circuit 44-1.

When the lock flag (th0-CAS-LOCK) of the thread 0 is set (its value is “1”) and the lock flag (th1-CAS-LOCK) of the thread 1 is cleared (its value is “0”), the value of the output of the OR circuit 42-0 becomes “1” and the value of the output of the OR circuit 42-1 becomes “0”. Therefore, the store request issued by the store request issuing unit 41-0 for the thread 0 is supplied to the processing unit 45 of the pipeline via the AND circuit 44-0, and the supply of the store request issued by the store request issuing unit 41-1 for the thread 1 to the processing unit 45 of the pipeline is prohibited.

When the lock flag (th0-CAS-LOCK) of the thread 0 is cleared (its value is “0”) and the lock flag (th1-CAS-LOCK) of the thread 1 is set (its value is “1”), the value of the output of the OR circuit 42-0 becomes “0” and the value of the output of the OR circuit 42-1 becomes “1”. Therefore, the supply of the store request issued by the store request issuing unit 41-0 for the thread 0 to the processing unit 45 of the pipeline is prohibited and the store request issued by the store request issuing unit 41-1 for the thread 1 is supplied to the processing unit 45 of the pipeline via the AND circuit 44-1.

When the lock flag (th0-CAS-LOCK) of the thread 0 and the lock flag (th1-CAS-LOCK) of the thread 1 are both set (their values are “1”), the values of the outputs of the OR circuits 42-0, 42-1 both become “1”. Therefore, the store request issued by the store request issuing unit 41-0 for the thread 0 is supplied to the processing unit 45 of the pipeline via the AND circuit 44-0, and the store request issued by the store request issuing unit 41-1 for the thread 1 is supplied to the processing unit 45 of the pipeline via the AND circuit 44-1.

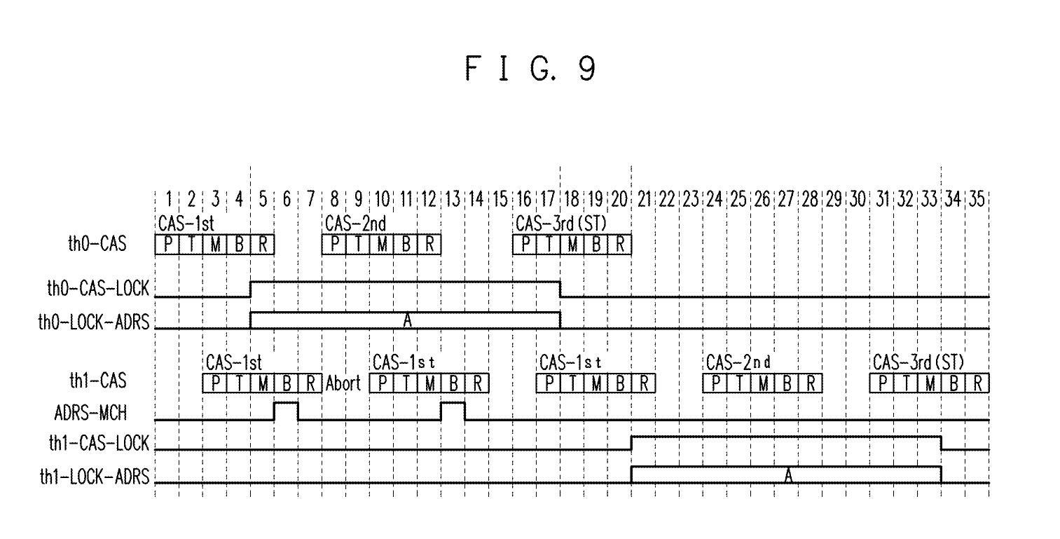

FIG. 9 is a timing chart illustrating an operation example of the processor 10 in this embodiment. FIG. 9 illustrate a case where an access address of the CAS instruction of the thread 0 and an access address of the CAS instruction of the thread 1 are the same.

The CAS instruction (th0-CAS) of the thread 0 is first executed, and the pipeline 21 of the primary cache controller 15 sets the lock flag (th0-CAS-LOCK) of the thread 0 in the lock register 24-0 at the fifth cycle. At this time, the pipeline 21 of the primary cache controller 15 sets a value A as the lock address (th0-CAS-ADRS) of the thread 0 in the lock register 25-0.

From the third cycle, the CAS instruction (th1-CAS) of the thread 1 starts to flow. However, at the sixth cycle, the pipeline 21 of the primary cache controller 15 aborts it since the address of an access target agrees with the lock address (th0-CAS-ADRS) of the thread 0 whose lock flag is set (ADRS-MCH is “1”). Further, the CAS instruction (th1-CAS) of the thread 1 starting from the tenth cycle is similarly aborted.

The pipeline 21 of the primary cache controller 15 executes the first operation flow, the second operation flow, and the third operation flow relating to the CAS instruction (th0-CAS) of the thread 0 in sequence. Then, the pipeline 21 of the primary cache controller 15 clears the lock flag (th0-CAS-LOCK) of the thread 0 and the lock address (th0-CAS-ADRS) of the thread 0 at the eighteenth cycle.

The CAS instruction (th1-CAS) of the thread 1 starts to flow from the seventeenth cycle. The pipeline 21 of the primary cache controller 15 sets the lock flag (th1-CAS-LOCK) of the thread 1 in the lock register 24-1 at the twenty-first cycle since the lock flag (th0-CAS-LOCK) of the thread 0 is cleared at the eighteenth cycle. At this time, the pipeline 21 of the primary cache controller 15 sets the value A as the lock address (th1-CAS-ADRS) of the thread 1 in the lock register 25-1.

Thereafter, the pipeline 21 of the primary cache controller 15 executes the second operation flow and the third operation flow relating to the CAS instruction (th1-CAS) of the thread 1 in sequence and clears the lock flag (th1-CAS-LOCK) of the thread 1 and the lock address (th1-CAS-ADRS) of the thread 1 at the thirty-fourth cycle.

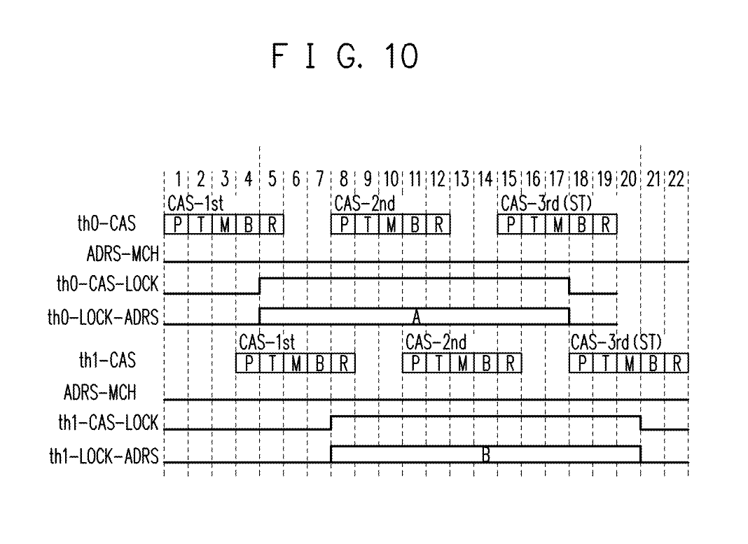

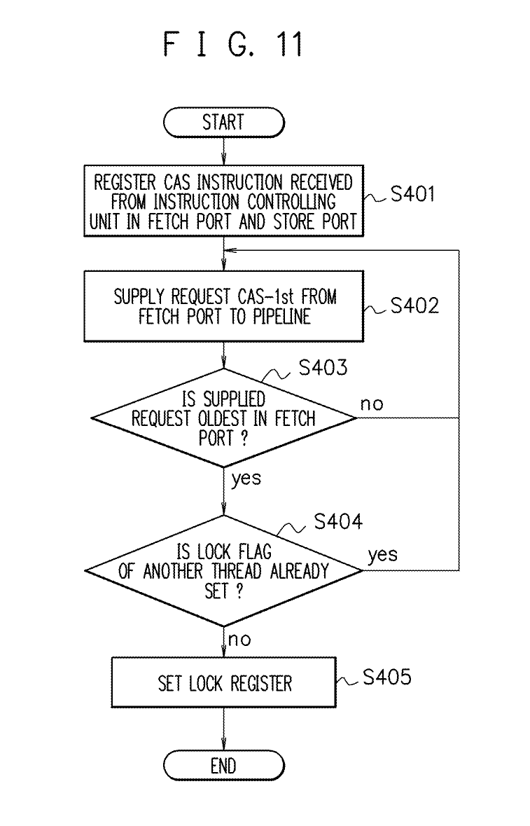

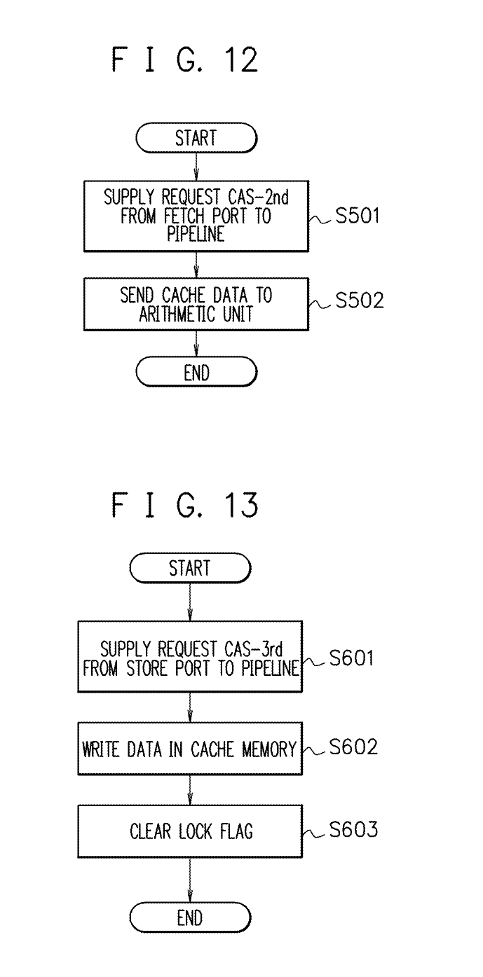

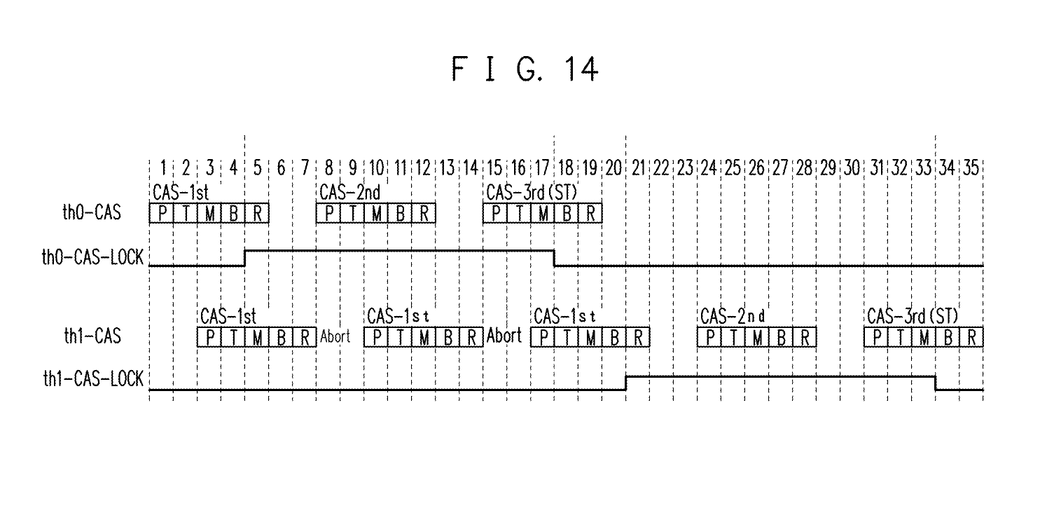

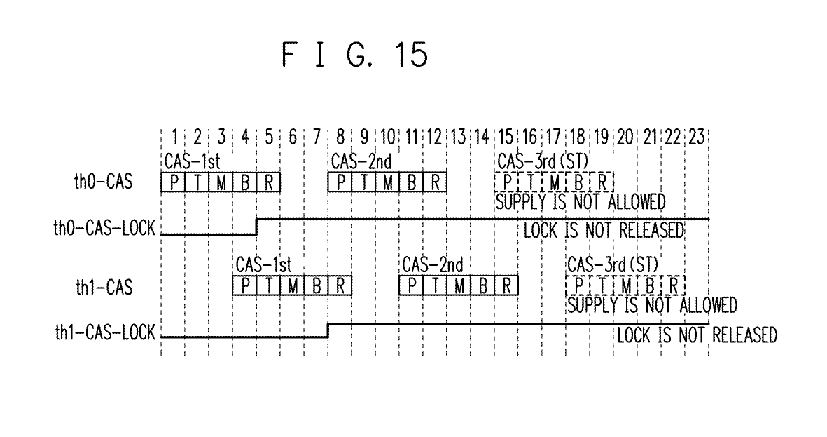

FIG. 10 is a timing chart illustrating an operation example of the processor 10 in this embodiment. FIG. 10 illustrates a case where an access address of the CAS instruction of the thread 0 and an access address of the CAS instruction of the thread 1 are different.

The same thing as that of the example illustrated in FIG. 9 applies to the CAS instruction (th0-CAS) of the thread 0 executed first. The CAS instruction (th1-CAS) of the thread 1 starts to flow from the fourth cycle. This CAS instruction (th1-CAS) of the thread 1 is not aborted since the address of an access target in the CAS instruction of the thread 1 is a value B and is different from the value A of the address of the access target in the CAS instruction of the thread 0 and thus the addresses do not agree in the address comparison at the seventh cycle (ADRS-MCH is “0”).

As a result, the pipeline 21 of the primary cache controller 15 sets the lock flag (th1-CAS-LOCK) of the thread 1 in the lock register 24-1 at the eighth cycle. At this time, the pipeline 21 of the primary cache controller 15 sets the value B as the lock address (th1-CAS-ADRS) of the thread 1 in the lock register 25-1.

Then, the pipeline 21 of the primary cache controller 15 sequentially executes the first operation flows, the second operation flows, and the third operation flows relating to the CAS instructions of the threads 0, 1. Here, the third request (store request) relating to the CAS instruction (th0-CAS) of the thread 0 can be supplied in this embodiment even though the lock flag (th1-CAS-LOCk) of the thread 1 is set, and the pipeline 21 of the primary cache controller 15 executes the processing of the third operation flow.

Then, the pipeline 21 of the primary cache controller 15 clears the lock flag (th0-CAS-LOCK) of the thread 0 and the lock address (th0-CAS-ADRS) of the thread 0 at the eighteenth cycle. Further, regarding the thread 1, the pipeline 21 of the primary cache controller 15 also clears the lock flag (th1-CAS-LOCK) of the thread 1 and the lock address (th1-CAS-ADRS) of the thread 1 at the twenty-first cycle.

According to this embodiment, an address locked in the lock register of each thread is held, and when an address accessed by a CAS instruction is different from the lock address held in the lock register of another thread, the CAS instruction is made executable. Consequently, the CAS instructions to different addresses can be concurrently executed, so that the speed of the whole execution of the CAS instructions is increased, which can improve processing performance of the processor 10. Even when the CAS instructions are concurrently executed, since they are to different addresses, the supply of a store request is enabled while guaranteeing atomicity, and the occurrence of a deadlock can be avoided.

According to one embodiment, when an access target address of a CAS instruction and a lock target address of another thread whose lock information is held are different, a plurality of pieces of processing included in the instruction are executed, so that the CAS instructions of different threads can be concurrently executed, which can improve processing performance of a processor. Further, even when the CAS instructions are concurrently executed, store processing relating to the CAS instruction is not prohibited, which prevents the occurrence of a deadlock.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A processor comprising:
a cache memory which holds data;
an instruction controlling unit which requests processing according to an instruction in each of a plurality of threads;
an address holding unit which holds, for each of the plural threads, lock information indicating that an address is locked and a lock target address in correspondence to each of the threads; and
a cache controlling unit which, in a case where execution of an atomic instruction whose plurality of pieces of processing including an access to the cache memory are indivisibly executed is requested from the instruction controlling unit, executes the plural pieces of processing included in the atomic instruction when an access target address of the atomic instruction whose execution is requested is different from the lock target address of a thread whose lock information is held in the address holding unit, and prohibits execution of store processing of a thread whose lock information is not held in the address holding unit, to the cache memory when the lock information of any thread out of the plural threads is held in the address holding unit.

2. The processor according to claim 1, wherein the cache controlling unit comprises:
a comparator which compares, for each of the plural threads, the access target address of the atomic instruction whose execution is requested by the instruction controlling unit with the lock target address held in the address holding unit; and
an output circuit which, based on the lock information, outputs a result of the comparison of the comparator corresponding to a thread different from a thread requesting the execution of the atomic instruction, to a pipeline which executes the processing according to the instruction.

3. The processor according to claim 1, wherein the cache controlling unit further comprises:
a determining circuit which is provided for each of the plural threads and determines whether or not the lock information corresponding to the own thread is set in the address holding unit; and
a prohibiting circuit which prohibits the execution of the store processing of the own thread to the cache memory, based on a result of the determination of the determining circuit.

4. A control method of a processor including: a cache memory which holds data; and
an address holding unit which holds, for each of a plurality of threads, lock information indicating that an address is locked and a lock target address in correspondence to each of the threads, the control method comprising:
requesting processing according to an instruction in each of a plurality of threads, by an instruction controlling unit that the processor has;
in a case where execution of an atomic instruction whose plurality of pieces of processing including an access to the cache memory are indivisibly executed is requested from the instruction controlling unit, executing the plural pieces of processing included in the atomic instruction when an access target address of the atomic instruction whose execution is requested is different from the lock target address of a thread whose lock information is held in the address holding unit, by a cache controlling unit that the processor has; and
prohibiting execution of store processing of a thread whose lock information is not held in the address holding unit, to the cache memory when the lock information of any thread out of the plural threads is held in the address holding unit, by the cache controlling unit.
